(19) United States
(12) Patent Application Publication
(10) Pub. No.: US 2016/0115874 A1
(43) Pub. Date: Apr. 28, 2016

(54) LINER GROMMET ASSEMBLY

(71) Applicant: SOLAR TURBINES INCORPORATED, San Diego, CA (US)

(72) Inventor: Ramarao Venkat Bandaru, San Diego, CA (US)

(73) Assignee: SOLAR TURBINES INCORPORATED, San Diego, CA (US)

(21) Appl. No.: 14/526,318

(22) Filed: Oct. 28, 2014

(51) Int. Cl. F02C 7/32; F28F 1/00

(52) U.S. Cl. CPC F02C 7/32; F28F 1/00; F05D 2240/35; F05D 2260/30

(57) ABSTRACT

A base for a grommet assembly of a combustion chamber is disclosed. The base includes a base body and a cooling extension. The base body includes a first body portion having a first hollow cylinder sector shape and a second body portion having a second hollow cylinder sector shape. The first portion is thicker than the second portion. The cooling extension includes a cylindrical portion with a third hollow cylinder sector shape and an annular portion. The cylindrical portion extends axially from the base body. The annular portion extends radially from the cylindrical portion distal to the base body.

### TECHNICAL FIELD

The present disclosure generally pertains to gas turbine engines, and is directed toward a grommet assembly for combustion chamber of a gas turbine engine.

### BACKGROUND

Gas turbine engines include compressor, combustor, and turbine sections. A grommet may be located in a combustor liner to provide access into the area where the combustion process occurs.

U.S. Patent App. Pub. No. 2014/0083112 to Jouse et al. discloses a combustor liner grommet that may include a peripheral wall defining a hole in a combustor liner and further including at least one cooling air flow channel. The cooling air flow channel in the grommet wall may be a slot or a hole. The channel may increase cooling flow to the grommet and the combustor liner around the grommet to prevent cracking from heat stress.

The present disclosure is directed toward overcoming one or more of the problems discovered by the inventors or that is known in the art.

### SUMMARY OF THE DISCLOSURE

A grommet assembly for a combustor of a gas turbine engine is disclosed. In embodiments, the grommet assembly includes a base. The base includes a base body and a cooling extension. The base body includes a first body portion having a first hollow cylinder sector shape and a second body portion having a second hollow cylinder sector shape. The first portion is thicker than the second portion. The cooling extension includes a cylindrical portion with a third hollow cylinder sector shape and an annular portion. The cylindrical portion extends axially from the base body. The annular portion extends radially from the cylindrical portion distal to the base body.

In embodiments, the grommet assembly also includes a grommet including a grommet body with a first hollow cylinder shape, a grommet footing with a second hollow cylinder shape, and a grommet top with a funnel shape. The grommet footing extends radially outward from the grommet body and is joined to the base body. The grommet top extends outward from the grommet body distal to the grommet footing.

In embodiments, the grommet assembly further includes a retainer ring including a retainer body with a third hollow cylinder shape and a retainer top portion. The retainer body is located radially outward from the grommet footing and the base body forming an air gap there between. The retainer top portion extends inward from the retainer body and is located radially outward from the grommet body.

### BRIEF DESCRIPTION OF THE DRAWINGS

FIG. 1 is a schematic illustration of an exemplary gas turbine engine.

FIG. 2 is a perspective view of a portion of the combustion chamber of FIG. 1.

FIG. 3 is an exploded view of the grommet assembly and the outer liner of FIG. 2.

FIG. 4 is a perspective view of the base of FIG. 3.

FIG. 5 is a side view of the retainer ring of FIG. 3.

FIG. 6 is a cross-sectional view of the grommet assembly of FIGS. 2 and 3.

### DETAILED DESCRIPTION

The systems and methods disclosed herein include a combustion chamber with a grommet assembly. The grommet assembly provides access into the combustion chamber includes a base joined to a grommet. The base includes a cooling extension that directs cooling air along an interior surface of a louver lip of the combustion chamber outer liner. The cooling air may act as a buffer and prevent the combustion flame from getting too close to the louver lip and may cool the louver lip by convection.

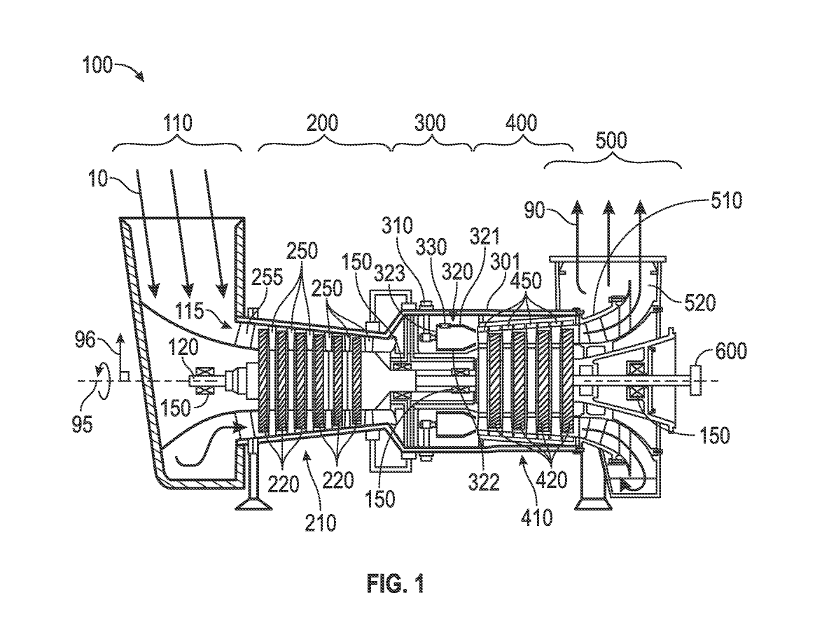

FIG. 1 is a schematic illustration of an exemplary gas turbine engine 100. Some of the surfaces have been left out or exaggerated (here and in other figures) for clarity and ease of explanation. Also, the disclosure may reference a forward and an aft direction. Generally, all references to “forward” and “aft” are associated with the flow direction of primary air (i.e., air used in the combustion process), unless specified otherwise. For example, forward is “upstream” relative to primary air flow, and aft is “downstream” relative to primary air flow.

In addition, the disclosure may generally reference a center axis 95 of rotation of the gas turbine engine, which may be generally defined by the longitudinal axis of its shaft 120 (supported by a plurality of bearing assemblies 150). The center axis 95 may be common to or shared with various other engine concentric components. All references to radial, axial, and circumferential directions and measures refer to center axis 95, unless specified otherwise, and terms such as “inner” and “outer” generally indicate a lesser or greater radial distance from center axis 95, wherein a radial 96 may be in any direction perpendicular and radiating outward from center axis 95.

A gas turbine engine 100 includes an inlet 110, a shaft 120, a compressor 200, a combustor 300, a turbine 400, an exhaust 500, and a power output coupling 600. The gas turbine engine 100 may have a single shaft or a dual shaft configuration.

The compressor 200 includes a compressor rotor assembly 210, compressor stationary vanes (stators) 250, and inlet guide vanes 255. The compressor rotor assembly 210 mechanically couples to shaft 120. As illustrated, the compressor rotor assembly 210 is an axial flow rotor assembly. The compressor rotor assembly 210 includes one or more compressor disk assemblies 220. Each compressor disk assembly 220 includes a compressor rotor disk that is circumferentially populated with compressor rotor blades. Stators 250 axially follow each of the compressor disk assemblies 220. Each compressor disk assembly 220 paired with the adjacent stators 250 that follow the compressor disk assembly 220 is considered a compressor stage. Compressor 200 includes multiple compressor stages. Inlet guide vanes 255 axially precede the compressor stages.

The combustor 300 includes a combustion chambers 320, one or more fuel injectors 310, and a combustor case 301 located radially outward from the combustion chamber 320. Combustion chamber 320 may include an outer liner 321, an inner liner 322, a dome plate 323, and a grommet assembly 330. Outer liner 321 may define the outer boundary of combustion chamber 320 and may generally include a hollow cylinder shape. Inner liner 322 may be located radially inward from outer liner 321. Inner liner 322 may define the inner boundary of combustion chamber 320 and may generally include a hollow cylinder shape. Dome plate 323 may define the forward boundary of combustion chamber 320 and may extend between the outer liner 321 and the inner liner 322. Dome plate 323 may be a disk shaped like an annulus. Grommet assembly 330 may be secured to outer liner 321 and may provide radial access to combustion chamber 320 there through. Grommet assembly 330 is used to access the combustor interior. In the embodiments illustrated herein, grommet assembly 330 is a torch grommet assembly.

The turbine 400 includes a turbine rotor assembly 410 and turbine nozzles 450. The turbine rotor assembly 410 mechanically couples to the shaft 120. As illustrated, the turbine rotor assembly 410 is an axial flow rotor assembly. The turbine rotor assembly 410 includes one or more turbine disk assemblies 420. Each turbine disk assembly 420 includes a turbine disk that is circumferentially populated with turbine blades. Turbine nozzles 450 axially precede each of the turbine disk assemblies 420. Each turbine disk assembly 420 paired with the adjacent turbine nozzles 450 that precede the turbine disk assembly 420 is considered a turbine stage. Turbine 400 includes multiple turbine stages.

The exhaust 500 includes an exhaust diffuser 510 and an exhaust collector 520. The power output coupling 600 may be located at an end of shaft 120.

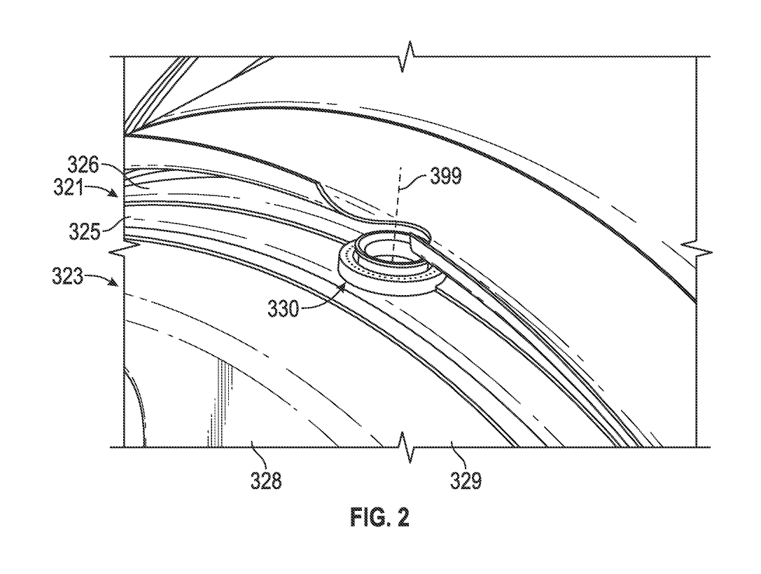

FIG. 2 is a perspective view of a portion of the combustion chamber 320 of FIG. 1. Dome plate 323 may include a dome plate face 328 that forms the forward wall of the combustion chamber 320 and a dome plate connector 329 that extends axially from the dome plate face 328. Dome plate connector 329 may include a hollow cylinder shape and may be configured to connect dome plate 323 to outer liner 321.

Outer liner 321 may be formed by multiple sections joined together. These sections may be joined by metallurgical bonds, such as welds or brazes. In the embodiment illustrated, outer liner 321 includes a first liner section 325 and a second liner section 326. First liner section 325 may be joined to dome plate connector 329 by a metallurgical bond. First liner section 325 may be a solid of revolution and may generally include a cylindrical shape. Second liner section 326 may overlap with and be joined by a metallurgical bond to first liner section 325. Second liner section 326 may be a solid of revolution and may generally include a cylindrical shape.

Grommet assembly 330 may be joined to outer liner 321 by a metallurgical bond. In the embodiment illustrated, grommet assembly 330 is joined to outer liner 321 at first liner section 325 where first liner section 325 and second liner section 326 overlap. Grommet assembly 330 may generally revolve about an assembly axis 399. All references to radial, axial, and circumferential directions and measures with reference to grommet assembly 330 and its components refer to assembly axis 399 and terms such as “inner” and “outer” generally indicate a lesser or greater radial distance from assembly axis 399.

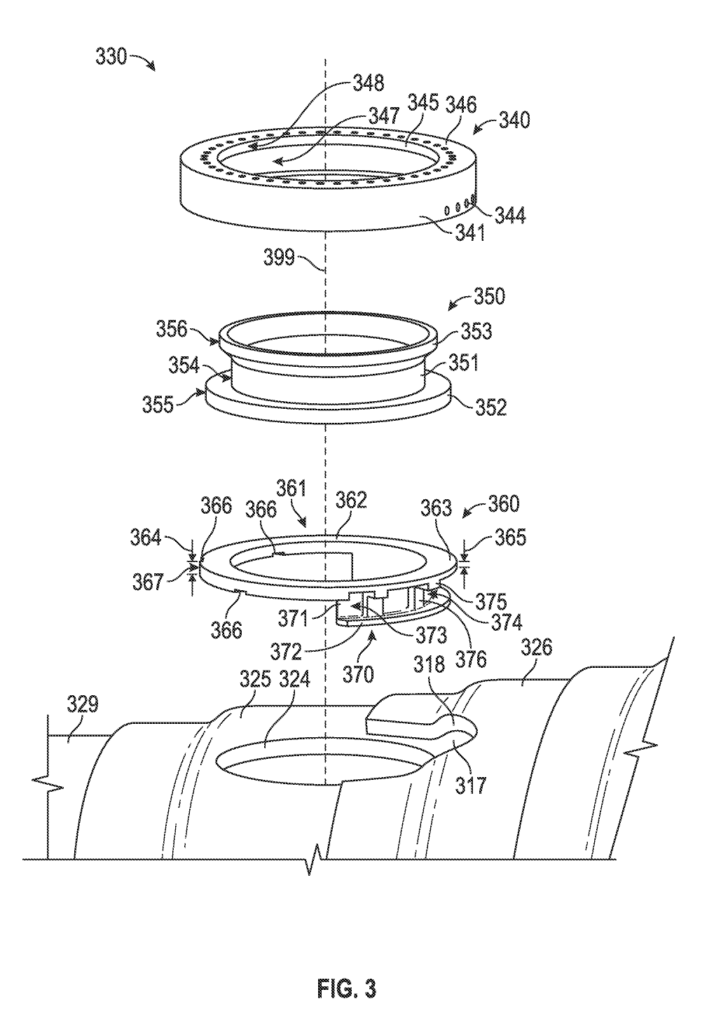

FIG. 3 is an exploded view of the grommet assembly 330 and outer liner 321 of FIG. 2. Outer liner 321 includes a chamber access port 324. Second liner section 326 may include may include a cut out portion 318. Cut out portion 318 may include a diameter slightly larger than the diameter of chamber access port 324. First liner section 325 and second liner section 326 may be configured with a an cooling passage 317 adjacent chamber access port 324 and cut out portion 318. Chamber access port 324 may extend radially through outer liner 321 at first liner section 325. Grommet assembly 330 may include a base 360, a grommet 350, and a retainer ring 340. Base 360 may include a base body 361, a cooling extension 370, and standoffs 374.

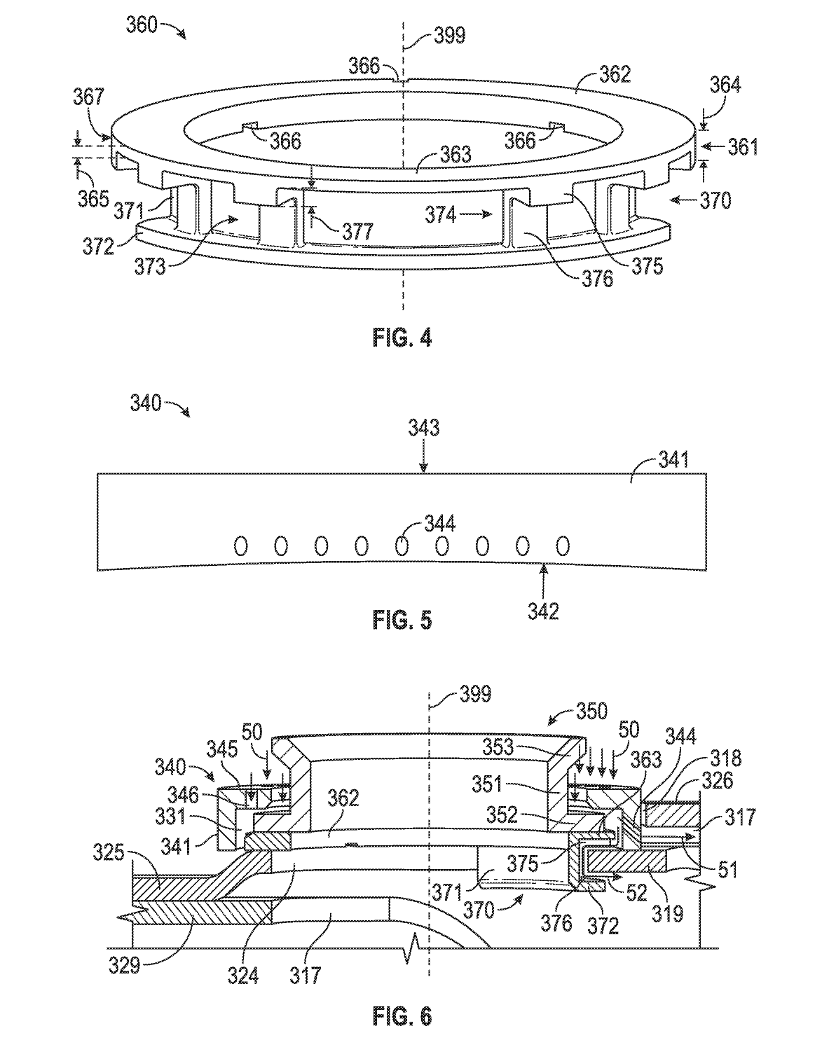

FIG. 4 is a perspective view of the base 360 of FIG. 3. Referring to FIGS. 3 and 4, base body 361 may generally be in the shape of a hollow cylinder. Base body 361 may include a first body portion 362 and a second body portion 363. First body portion 362 may be in the shape of a sector of a hollow cylinder. Second body portion 363 may also be in the shape of a sector of a hollow cylinder and may include the same inner and outer radii as first body portion 362. First body portion 362 and second body portion 363 may form the hollow cylinder shape of base body 361. The arc length and central angle of the first body portion 362 may be larger than the arc length and central angle of the second body portion 363.

First body portion 362 may include a first body height 364, the axial thickness of first body portion 362. Second body portion 363 may include a second body height 365, the axial thickness of second body portion 363. First body height 364 may be greater than second body height 365.

Cooling extension 370 includes a cylindrical portion 371 and an annular portion 372. Cylindrical portion 371 extends axially from base body 361. As illustrated, cylindrical portion 371 may extend from the radially inner part of base body 361 and may include a radial thickness that is less than the radial thickness of base body 361.

Cylindrical portion 371 may be in the shape of a sector of a hollow cylinder. The arc length and a central angle of cylindrical portion 371 may be at least equal to the arc length and central angle of second body portion 363. In the embodiment illustrated, the arc length and central angle of cylindrical portion 371 are greater than the arc length and central angle of second body portion 363 so as to span the entire circumference of second body portion 363 and to overlap with first body portion 362 on each side of first body portion 362 adjacent the sides of second body portion 363. Cylindrical portion 371 may include a cylindrical portion surface 373. Cylindrical portion surface 373 is the radially outer surface of cylindrical portion 371.

Annular portion 372 extends radially outward from cylindrical portion 371. Annular portion 372 may extend from the end of cylindrical portion 371 opposite base body 361. Annular portion 372 may be in the shape of a sector of a hollow cylinder. The arc length and central angle of annular portion 372 may be equal to the arc length and central angle of cylindrical portion 371. Annular portion 372 may circumferentially align with cylindrical portion 371.

Standoffs 374 may include an upper portion 375 and a lower portion 376. Upper portion 375 may extend axially from second body portion 363 towards annular portion 372. Upper portion 375 may include an upper portion height 377. The combined thicknesses of upper portion 375 and second body portion 363 may equal the thickness of first body portion 362, such that the combined height of upper portion height 377 and second body height 365 equal first body height 364 or are within a predetermined tolerance of first body height 364. Lower portion 376 may extend axially outward from cylindrical portion 371. Upper portion 375 and lower portion 376 may form an ‘L’ shape. Standoffs 374 may be spaced apart along cylindrical portion surface 373.

Base 360 may also include locating features 366. Each locating feature 366 may be either a recess or a protrusion in base body 361 or cooling extension 370. In the embodiment illustrated, base 360 includes two locating features 366 in the first body portion 362 located along the radially inner edge and one locating feature 366 along the radially outer edge. The locating features 366 may be used to orient the base 360 relative to the outer liner 321, the grommet 350, and the retainer ring 340.

Referring to FIG. 3, grommet 350 may be a solid of revolution revolved about assembly axis 399. Grommet 350 may include a grommet body 351, a grommet footing 352, and a grommet top 353. Grommet body 351 may be in the shape of a hollow cylinder. Grommet body 351 may also include a grommet body outer surface 354. Grommet body outer surface 354 is a cylindrical surface.

Grommet footing 352 extends radially outward from grommet body 351 and may extend from an axial end of grommet body 351. Grommet footing 352 may be in the shape of a hollow cylinder. Grommet footing 352 may be axially narrower and radially thicker than grommet body 351. Grommet footing may include a grommet footing outer surface 355. Grommet footing outer surface 355 is the outer surface of grommet footing 352. Grommet footing outer surface 355 may be a cylindrical surface. The diameter of grommet footing outer surface 355 is larger than the diameter of grommet body outer surface 354.

Grommet top 353 may be distal to grommet footing 352 and may extend from the end of grommet body 351 opposite grommet footing 352. Grommet top 353 may be in the shape of a funnel. Grommet top 353 may extend from the end of grommet body 351 both axially away from grommet footing 352 and radially outward from grommet body 351 to form the funnel shape. Grommet top may include a grommet top surface 356. Grommet top surface 356 may be a cylindrical surface and may be an outer surface adjacent the end of grommet top 353 furthest from grommet body 351. Grommet top surface 356 may include a diameter larger than grommet body outer surface 354 and a diameter smaller than grommet footing outer surface 355.

FIG. 5 is a side view of the retainer ring 340 of FIG. 3. Referring to FIGS. 3 and 5, retainer ring 340 may generally be a solid of revolution revolved about assembly axis 399. Retainer ring 340 may include a retainer body 341 and a retainer top portion 345. Retainer body 341 may generally be in the shape of a hollow cylinder. Retainer body 341 may include a retainer body surface 347, the radially inner surface of retainer body 341. Retainer body surface 347 may be in a cylindrical shape. Retainer body surface 347 may include a diameter that is larger than the diameter of grommet footing outer surface 355 and larger than the diameter of body outer surface 367.

Retainer top portion 345 may extend radially inward from an end of retainer body 341. Retainer top portion 345 may include a retainer top portion surface 348, the radially inner surface of retainer top portion 345. Retainer top portion surface 348 may be a cylindrical shape. The diameter of retainer top portion surface 348 is smaller than the diameter of retainer body surface 347. The diameter of retainer top portion surface 348 may also be larger than the diameter of grommet body outer surface 354.

Retainer ring 340 may also include a retainer top surface 343 and a retainer bottom surface 342. Retainer top surface 343 may be relatively flat and may be perpendicular to assembly axis 399. Retainer top surface 343 may be in the shape of an annulus. Retainer top surface 343 may span across retainer top portion 345. Retainer bottom surface 342 may be located opposite retainer top portion 345. Retainer bottom surface 342 may generally be an annulus that is curved to match the curvature of outer liner 321 so that retainer bottom surface 342 generally contacts outer liner 321 about its circumference.

Retainer ring 340 may further include angled holes 344 and holes 346. Angled holes 344 may extend through retainer body 341. Holes 346 may extend through retainer top 343.

FIG. 6 is a cross-sectional view of the grommet assembly 330 of FIGS. 2 and 3. As illustrated, grommet assembly 330 aligns with chamber access port 324. Base 360 is configured to contact outer liner 321 about chamber access port 324. Base 360 may be joined to outer liner 321 by a metallurgical bond, such as a weld or braze. Base 360 may be oriented so that cooling extension 370 is adjacent an louver lip 319 of first liner section 325, the louver lip 319 being situated at the aft end of first liner section 325 adjacent chamber access port 324. The standoffs 374 including upper portion 375 and lower portion 376 may contact outer liner 321 at louver lip 319. Upper portion 375 may be configured to maintain an axial clearance between second body portion 363 and louver lip 319 forming an air gap there between. Lower portion 376 may be configured to maintain a radial clearance between cylindrical portion 371 and louver lip 319. The axial length of cylindrical portion 371 may be such that there is also an axial clearance between annular portion 372 and louver lip 319. The clearances between second body portion 363, cylindrical portion 371, and annular portion 372 with louver lip 319 may form a first cooling path 52. First cooling path 52 may include a ‘U’ shaped cross section.

Grommet 350 may be joined to base 360 by a metallurgical bond, such as a weld or braze. Grommet footing 352 may contact base body 361 and may be oriented so that grommet body 351 extends away from base 360. The metallurgical bond may join grommet footing 351 to base body 361. Base body 361 may separate grommet footing 352 from outer liner 321.

Retainer ring 340 may be joined to outer liner 321 by a metallurgical bond, such as a weld or braze. Retainer body 341 may be located outward and spaced apart from base body 361 and grommet footing 352 forming an air gap 331 there between. Angled holes 344 may be angled to direct air from the air gap 331 into a cooling passage 317 between first liner section 325 and second liner section 326 along a second cooling path 51. Cooling passage 317 may be adjacent louver lip 319.

Retainer top portion 345 may be located outward and spaced apart from grommet body 351, and may be axially spaced apart from grommet footing 352. Retainer ring 340 and grommet 350 are configured to allow cooling air 50 to enter into air gap 331 and to be directed along first cooling path 52 and second cooling path 51.

One or more of the above components (or their subcomponents) may be made from stainless steel and/or durable, high temperature materials known as “superalloys”. A superalloy, or high-performance alloy, is an alloy that exhibits excellent mechanical strength and creep resistance at high temperatures, good surface stability, and corrosion and oxidation resistance. Superalloys may include materials such as HASTELLOY, alloy x, INCONEL, WASPALOY, RENE alloys, HAYNES alloys, alloy 188, alloy 230, INCOLOY, MP98T, TMS alloys, and CMSX single crystal alloys.

### INDUSTRIAL APPLICABILITY

Gas turbine engines may be suited for any number of industrial applications such as various aspects of the oil and gas industry (including transmission, gathering, storage, withdrawal, and lifting of oil and natural gas), the power generation industry, cogeneration, aerospace, and other transportation industries.

Referring to FIG. 1, a gas (typically air 10) enters the inlet 110 as a “working fluid”, and is compressed by the compressor 200. In the compressor 200, the working fluid is compressed in an annular flow path 115 by the series of compressor disk assemblies 220. In particular, the air 10 is compressed in numbered “stages”, the stages being associated with each compressor disk assembly 220. For example, “4th stage air” may be associated with the 4th compressor disk assembly 220 in the downstream or “aft” direction, going from the inlet 110 towards the exhaust 500). Likewise, each turbine disk assembly 420 may be associated with a numbered stage.

Once compressed air 10 leaves the compressor 200, it enters the combustor 300, where it is diffused and fuel is added. Air 10 and fuel are injected into the combustion chamber 320 via fuel injector 310 and combusted. Energy is extracted from the combustion reaction via the turbine 400 by each stage of the series of turbine disk assemblies 420. Exhaust gas 90 may then be diffused in exhaust diffuser 510, collected and redirected. Exhaust gas 90 exits the system via an exhaust collector 520 and may be further processed (e.g., to reduce harmful emissions, and/or to recover heat from the exhaust gas 90).

Grommets may be used in combustor liners to provide access into the area where the combustion process occurs. There may be a pressure difference across the boundary of the combustor liner. A grommet may help prevent movement of gases across the boundary at an access port. However, hot spots may develop in the combustion liner around the access port.

Grommet assembly 330 may help maintain a more uniform wall temperature of outer liner 321 at and around chamber access port 324. The ‘U’ shaped channel formed between base 360 and louver lip 319 may direct cooling air from the first cooling path 52 to and along the interior surface of the louver lip 319. This cooling air may prevent a portion of the flame from bending towards and heating louver lip 319 adjacent grommet assembly 330. The cooling air 50 may also provide convective cooling for the louver lip 319 adjacent the grommet assembly 330.

Angled holes 344 may direct cooling air 50 along second cooling path 51 and into cooling passage 317. Cooling air 50 from cooling passage 317 may be directed along second liner section 326 to keep the portion of second liner section 326 adjacent grommet assembly 330 cool.

The preceding detailed description is merely exemplary in nature and is not intended to limit the invention or the application and uses of the invention. The described embodiments are not limited to use in conjunction with a particular type of gas turbine engine. Hence, although the present disclosure, for convenience of explanation, depicts and describes a particular grommet assembly, it will be appreciated that the grommet assembly in accordance with this disclosure can be implemented in various other configurations to access the combustor interior, can be used with various other types of gas turbine engines, and can be used in other types of machines. Furthermore, there is no intention to be bound by any theory presented in the preceding background or detailed description. It is also understood that the illustrations may include exaggerated dimensions to better illustrate the referenced items shown, and are not consider limiting unless expressly stated as such.

What is claimed is:

1. A grommet assembly for a combustion chamber of a gas turbine engine, the combustion chamber including an outer liner and a chamber access port in the outer liner, the grommet assembly comprising:
a base including
a base body with a first hollow cylinder shape, the base body including
a first body portion with a first shape of a first hollow cylinder sector shape, the first body portion including a first body height, and
a second body portion with a second hollow cylinder sector shape, the second body portion including a second body height that is less than the first body height, and
a cooling extension including
a cylindrical portion with a third hollow cylinder sector shape extending axially from the base body and aligning circumferentially with the second body portion, and
an annular portion extending radially from the cylindrical portion distal to the base body; and
a grommet including
a grommet body with a second hollow cylinder shape,
a grommet footing with a third hollow cylinder shape extending radially outward from the grommet body, the grommet footing being joined to the base body, and
a grommet top with a funnel shape extending outward from the grommet body distal to the grommet footing.

2. The grommet assembly of claim 1, wherein the base body includes a body outer surface with a first diameter spanning the outer circumferences of the first body portion and the second body portion, the grommet body includes a grommet body outer surface with a second diameter, and the grommet footing includes a grommet footing outer surface with a third diameter that is larger than the second diameter.

3. The grommet assembly of claim 2, further comprising:
a retainer ring including
a retainer body with a fourth hollow cylinder shape, the retainer body including a retainer body surface with a fourth diameter that is larger than the third diameter, the retainer body surface being the interior surface of the retainer body, and
a retainer top portion extending inward from the retainer body to a retainer top portion surface with a fifth diameter, the fifth diameter being smaller than the fourth diameter and larger than the second diameter.

4. The grommet assembly of claim 3, wherein the retainer ring includes angled holes extending through the retainer body and configured to circumferentially align with the cooling extension when the grommet assembly is joined to the outer liner.

5. The grommet assembly of claim 4, wherein the retainer ring includes holes extending through the retainer top portion.

6. The grommet assembly of claim 1, wherein the base further includes a standoff including
an upper portion extending from the second body portion toward the annular portion, and
a lower portion extending outward from the cylindrical portion.

7. The grommet assembly of claim 6, wherein the upper portion includes an upper portion height, wherein the combined height of the second body height and the upper portion height equal the first body height.

8. The grommet assembly of claim 1, wherein the cooling extension extends the entire circumference of the second body portion and circumferentially overlaps with the first body portion.

9. A combustion chamber of a gas turbine engine, the combustion chamber comprising:
an outer liner including
a first liner section, and
chamber access port extending through the first liner section;
a base including
a base body with a first hollow cylinder shape, the base body including
a first body portion with a first shape of a first hollow cylinder sector shape joined to the first liner section, the first body portion including a first body height, and
a second body portion with a second hollow cylinder sector shape spaced apart from the first liner section, the second body portion including a second body height that is less than the first body height, and
a cooling extension including
a cylindrical portion with a third hollow cylinder sector shape extending axially from the base body and through the chamber access port, and
an annular portion extending radially from the cylindrical portion distal to the base body and spaced apart from the first liner section; and
a grommet including
a grommet body with a second hollow cylinder shape,
a grommet footing with a third hollow cylinder shape extending radially outward from the grommet body, the grommet footing being joined to the base body, and
a grommet top with a funnel shape extending outward from the grommet body distal to the grommet footing.

10. The combustion chamber of claim 9, wherein the first liner section includes a louver lip at an aft end and the outer liner includes a second liner section joined to the first liner section adjacent the louver lip and forming a cooling passage between the louver lip and the second liner section, the second liner section including a cut out portion aligned with the chamber access port and including a diameter that is larger than that of the access port.

11. The combustion chamber of claim 10, further comprising:
a retainer ring including
a retainer body with a fourth hollow cylinder shape joined to the first liner section, the retainer body located radially outward of the grommet footing and the base body forming an air gap there between, and
a retainer top portion extending inward from the retainer body distal to the first liner section, the retainer top portion located radially outward of the grommet body.

12. The combustion chamber of claim 11, wherein the retainer ring includes angled holes extending through the retainer body and aligning circumferentially with the cooling extension, the angled holes being configured to direct cooling air from the air gap and into the cooling passage.

13. The combustion chamber of claim 9, wherein the base further includes a standoff including
an upper portion extending from the second body portion toward the annular portion and contacting the first liner section, and
a lower portion extending outward from the cylindrical portion and contacting the first liner section at the chamber access port.

14. The combustion chamber of claim 13, wherein the upper portion includes an upper portion height, wherein the combined height of the second body height and the upper portion height equal the first body height.

15. The combustion chamber of claim 9, wherein the cooling extension extends the entire circumference of the second body portion and circumferentially overlaps with the first body portion.

16. A base for a grommet assembly of a combustion chamber for a gas turbine engine, the base comprising:
a base body with a hollow cylinder shape, the base body including
a first body portion with a first shape of a first hollow cylinder sector shape having a first arc length, and
a second body portion with a second hollow cylinder sector shape having a second arc length that is less than the first arc length, the first body portion being thicker than the second body portion; and
a cooling extension including
a cylindrical portion with a third hollow cylinder sector shape extending axially from the base body and aligning circumferentially with the second body portion, and
an annular portion extending radially from the cylindrical portion distal to the base body.

17. The base of claim 16, wherein the cylindrical portion has a third arc length that is greater than the second arc length such that the cooling extension extends the entire circumference of the second body portion and circumferentially overlaps with the first body portion.

18. The base of claim 16, further comprising:
a standoff including
an upper portion extending from the second body portion toward the annular portion, and
a lower portion extending outward from the cylindrical portion.

19. The base of claim 18, wherein a combined thickness of the second body portion and the upper portion equal a thickness of the first body portion.

20. The base of claim 16, further comprising a grommet joined to the base body, the grommet including:
a grommet body with a second hollow cylinder shape,
a grommet footing with a third hollow cylinder shape extending radially outward from the grommet body, the grommet footing being joined to the base body, and
a grommet top with a funnel shape extending outward from the grommet body distal to the grommet footing.
